(19) United States
(12) Patent Application Publication
(10) Pub. No.: US 2026/0166462 A1
(43) Pub. Date: Jun. 18, 2026

(54) MOISTURE AND PARTICULATE FILTRATION SYSTEM

(71) Applicant: Brookaire Company, LLC, East Rutherford, NJ (US)

(72) Inventor: Santhosh Kumar Pulipara Damodaran, Kerala (IN)

(21) Appl. No.: 19/421,373

(22) Filed: Dec. 16, 2025

Related U.S. Application Data
(60) Provisional application No. 63/734,974, filed on Dec. 17, 2024.

(51) Int. Cl. B01D 46/52; B01D 46/00

(52) U.S. Cl. CPC B01D 46/52; B01D 46/0002; B01D 2239/0428; B01D 2239/0618; B01D 2239/065

(57) ABSTRACT

An air filtration system is provided herein that can include a first layer comprising a hydrophobic non-woven material configured to repel moisture from the incoming air stream. The air filtration system can include a second layer positioned downstream of the first layer, comprising a lofted non-woven structure treated with a hydrophobic compound to capture additional moisture while allowing minimal resistance to airflow. The air filtration system can include a third layer positioned downstream of the second layer, comprising a dense non-woven material configured for particulate capture. The air filtration system can include a non-metal, non-woven frame encasing the layers configured to facilitate water drainage and maximize air exposure across the filtration surface.

### RELATED APPLICATIONS

This non-provisional patent application claims prior benefit, with regard to all subject matter, of U.S. Provisional Patent Application No. 63/734,974, filed Dec. 17, 2024, and titled “MOISTURE AND PARTICULATE FILTRATION SYSTEM”. The identified earlier-filed provisional patent application is hereby incorporated by reference in its entirety.

### BACKGROUND

Traditional air filters are generally designed to address either particulate removal or moisture reduction, but not both in a single integrated structure. In various applications, especially industrial, commercial, and healthcare environments, it is desirable to maintain both low particulate levels and controlled humidity for health, safety, and equipment longevity. However, conventional air filters struggle with these requirements due to several limitations.

### RELATED ART

Currently, traditional air filters are composed of single-layer materials or uniform structures that lack the ability to manage high moisture content effectively. Filters designed solely for particulate removal can become saturated with moisture, leading to reduced efficiency, increased air resistance, and, in some cases, microbial growth due to stagnant water accumulation. This issue is particularly problematic in humid environments, where air conditioning and ventilation systems may have to filter out both particulates and moisture continuously.

Another challenge is the maintenance and longevity of traditional filters in high-humidity applications. When filters become saturated with moisture, they tend to clog, which increases the need for frequent replacements and maintenance. This not only raises operational costs but also leads to potential downtime, which can be highly disruptive, especially in critical environments such as hospitals, laboratories, or cleanrooms. The need for frequent replacement also contributes to environmental waste, as many filters are disposed of frequently due to water damage and reduced efficacy.

Moreover, there are inherent difficulties in achieving both particulate capture and humidity reduction without creating significant air resistance, which can strain ventilation systems. High air resistance translates to higher energy consumption, as fans and blowers need to work harder to push air through the filter. This increase in energy demand is costly and can also reduce the overall efficiency of the air filtration system, which is a growing concern as more facilities strive to implement energy-efficient and environmentally sustainable solutions.

In addition to functional challenges, traditional air filters are often designed with a rigid or metal frame, which can obstruct water drainage. This obstruction can lead to water pooling at the edges of the filter, further exacerbating moisture-related issues. The accumulation of water around the frame can also lead to corrosion in metal-based frames, diminishing filter durability and effectiveness over time.

### SUMMARY

Embodiments of the present disclosure address the above-mentioned challenges by providing a multi-layer air filter designed to efficiently reduce both humidity and particulate matter in an air stream. The filter comprises multiple layers, each with a specific material composition and function, working sequentially to tackle the demands of high humidity and high particulate environments. The first layer is a hydrophobic layer that repels moisture, preventing excessive water accumulation and enhancing the filter's longevity. Depending on the humidity conditions to be managed, the first layer may include one or more hydrophobic layers. For instance, it may consist of a single hydrophobic layer or, in other embodiments, two or more layers of hydrophobic material. The second layer is a non-woven material optimized for particulate capture, ensuring that the air exiting the filter is both low in humidity and a reduced amount of particulates.

The filter is encased within a non-metal, non-woven, lipless frame that maximizes the exposed surface area for air filtration while facilitating efficient water drainage. This frame design eliminates the risk of water pooling along the edges, which is common in conventional filters, and reduces the potential for microbial growth. Together, these features create a durable, low-maintenance filtration system that meets the demands of industrial, commercial, and residential applications requiring both moisture and particulate management. By addressing the combined challenges of humidity and particulate reduction in a single system, these embodiments offer a practical and effective solution that overcomes the limitations of traditional air filters.

In some aspects, the techniques described herein relate to an air filtration system for reducing both humidity and particulate matter in an air stream, including a first layer comprising one or more hydrophobic layers and a second layer positioned downstream of the second layer, including a dense non-woven material optimized for particulate capture; a non-metal, non-woven frame encasing the layers, configured to facilitate water drainage and maximize air exposure across the filtration surface.

In some aspects, the techniques described herein relate to a multi-layer air filter for sequential moisture and particulate reduction in an air stream, including an upstream layer of material configured to deflect moisture upon contact, a downstream dense fibrous layer designed to retain particulate matter and reduce air contaminants; a supporting frame made from non-metal materials, wherein the frame features smooth drainage paths for expelling moisture and minimizing air resistance.

In some aspects, the techniques described herein relate to a filtration assembly for reducing humidity and particulate content in an air stream, including: a first hydrophobic layer on the upstream side configured to prevent moisture intrusion; a second lofted hydrophobic layer positioned downstream, including a chemically treated structure to capture residual moisture with minimal airflow resistance; a third dense particulate-capturing layer positioned downstream, configured to retain particulate matter from the air stream; a non-metallic frame configured to support each layer and direct filtered water away from the filtration assembly.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present disclosure will be apparent from the following detailed description of the embodiments and the accompanying drawing figures.

### BRIEF DESCRIPTION OF THE DRAWING FIGURES

Embodiments of the present disclosure are described in detail below with reference to the attached drawing figures, wherein:

FIG. 1 shows an exploded view of an exemplary air filter in accordance with some embodiments of this disclosure.

FIG. 2 shows an illustration of an exemplary air filter in accordance with some embodiments of this disclosure.

FIG. 3 shows an illustration of an exemplary air filter in accordance with some embodiments of this disclosure.

FIG. 4 shows an illustration of an exemplary air filter in accordance with some embodiments of this disclosure.

FIG. 5 presents a diagram of the airflow path and filtration process of an exemplary air filter in accordance with some embodiments of this disclosure.

FIG. 6 shows an illustration of an exemplary air filter in accordance with some embodiments of this disclosure.

FIG. 7 shows an exploded view of an exemplary air filter in accordance with some embodiments of this disclosure.

FIG. 8 shows an exploded view of an exemplary air filter in accordance with some embodiments of this disclosure.

The drawing figures do not limit the present disclosure to the specific embodiments disclosed and described herein. The drawings are not necessarily to scale, emphasis instead being placed upon clearly illustrating the principles of the present disclosure.

### DETAILED DESCRIPTION

The following detailed description references the accompanying drawings that illustrate specific embodiments in which the present disclosure can be practiced. The embodiments are intended to describe aspects of the present disclosure in sufficient detail to enable those skilled in the art to practice the present disclosure. Other embodiments can be utilized, and changes can be made without departing from the scope of the present disclosure. The following detailed description is, therefore, not to be taken in a limiting sense. The scope of the present disclosure is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

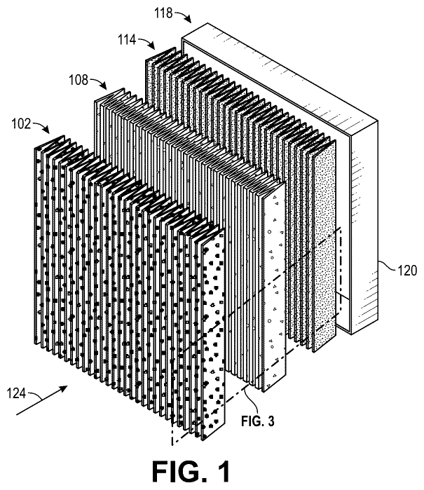

FIG. 1 depicts an expanded or exploded view of a three-layer air filter assembly configured for particulate and moisture removal from an incoming airstream. Each layer is composed of selected materials, each with a configuration to perform distinct filtration and moisture-repellent or removal functions. The assembly is encased within a non-metal frame designed to facilitate airflow and efficient water drainage.

In some embodiments, the first layer 102 is positioned on the upstream or air entry side, with the airflow direction 124 being from the first layer 102 to the second layer 108 and then to the third layer 114. The first layer can comprise a thin, non-woven material made from a hydrophobic material. The first layer 102, in some embodiments, comprises a lightweight, spun-bound material and serves as the initial moisture-repelling stage. Suitable materials for the first layer 202 can include but are not limited to, polypropylene, polyester, and polyethylene. For applications requiring higher moisture resistance or chemical compatibility, additional materials such as polyvinylidene fluoride (PVDF) or polytetrafluoroethylene (PTFE) can be utilized. These hydrophobic materials are designed to allow air to flow freely while preventing moisture penetration into subsequent layers. The hydrophobic nature of this layer enables it to act as an effective barrier against water droplets, which are deflected upon contact, thereby reducing the risk of moisture intrusion.

The second layer 108 is an intermediate layer and is configured between the first layer 102 and the third layer 114. The second layer 108 is a lofted, self-supporting structure that is thicker than the first layer. The second layer 108 is comprised of a non-woven material that may be treated with hydrophobic compounds to increase moisture resistance. The second layer 108 may comprise various non-woven synthetic fabrics, such as polyethylene terephthalate (PET), polypropylene, and fluoropolymer-based materials. The hydrophobic treatment applied to this layer may involve silicon-based compounds, fluorinated polymers, or other water-repellent coatings tailored to the application's specific environmental conditions. The lofted structure can be achieved through materials with self-supporting properties, such as melt-blown or needle-punched fibers, ensuring the layer's capability to trap excess moisture effectively without collapsing under collected dust or moisture.

The third layer 114 is located on the downstream or air exit side and is designed primarily for capturing fine particulate matter. This layer is comprised of synthetic, non-woven material., In some embodiments, the third layer 114 may be a high-lofted filter media. In further embodiments, the third layer 114 may have an electrostatic charge or be comprised of a nanofiber material or coating. In other embodiments, the third layer 114 is comprised of a dense, fibrous, non-woven material that creates a final barrier to trap any particulates not captured by the preceding layers. Suitable materials for this layer may include but are not limited to, polypropylene, polyester, acrylic, polyimide, glass fiber, or a combination of one or more materials. Polypropylene is lightweight and offers efficient particulate capture, while polyimide fibers provide enhanced thermal and chemical stability, making them ideal for environments where temperatures or contaminants are more severe. Glass fiber, though denser and heavier, may be advantageous in industrial applications that require high filtration efficiency and minimal airflow resistance.

In some embodiments, the three layers are encased in a frame 118, made from synthetic, non-woven material with a smooth, lipless edge to maximize the filtration area and enhance drainage. This frame 118 can be composed of a variety of materials, including non-woven polyester, polyethylene, or other thermoplastic elastomers. Frame 118 comprises a lipless edge 120, which allows any water captured or filtered from the air to drain away from the filter without accumulating within frame 118 and causing clogging. The frame 118 can be constructed using a non-metallic, non-woven structure. In some embodiments, frame 118 can comprise polyester, polyethylene, cardboard, fiberglass, thermoplastic elastomers, plastic, wood, wood fibers, or fiberboard.

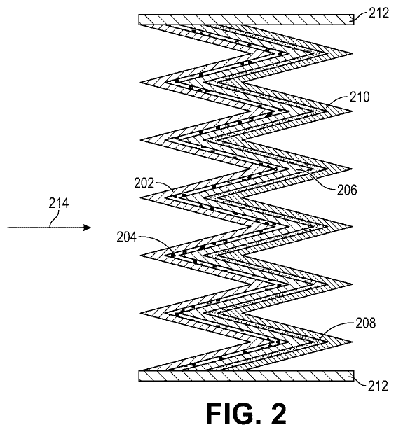

FIG. 2 provides a cross-sectional top-down view of the fully assembled multi-layer air filter, showing the upstream-to-downstream arrangement of the first layer 202, second layer 206, third layer 210, and frame 212. The cross-sectional view illustrates how air flows through each layer, gradually reducing humidity and particulate count with each stage. The cross-sectional view also illustrates the laminated nature of the fully assembled filter. For example, the first layer 202 is laminated to the second layer 206 by a first lamination layer 204. Additionally, the second layer 206 is laminated to the third layer 210 by a second lamination layer 208. In one embodiment, each of the first lamination layer 204 and the second lamination layer 208 are applied to the edges of the layers to secure them together. In another embodiment, each of the first lamination layer 204 and the second lamination layer 208 are applied to the surface of the layers to secure them together.

Each of the first lamination layer 204 and the second lamination layer 208 within FIG. 2 are placed between each filtration layer and are applied using a lamination process. The lamination process can involve materials such as thermosetting resin or two-part polyurethane. Other lamination processes and materials can be used. The lamination materials are chosen based on their durability, thermal stability, and compatibility with the various synthetic fibers and filtration layers within the system. When thermosetting resin is used, it provides a firm and permanent bond between layers, which is beneficial for applications requiring a highly stable structure that can withstand extended use and exposure to both moisture and particulate buildup. The resin's properties ensure minimal flexing or displacement of the filtration layers, preventing delamination even in high-flow or high-humidity conditions. The bonding strength of thermosetting resins also allows for a uniform distribution of tension across the layers, ensuring consistent air passage and pressure resistance throughout the filter's lifespan.

Each lamination layer is applied with a controlled adhesive spread, ensuring a consistent bond and preventing excess resin or adhesive that could interfere with airflow or filtration efficiency. In some embodiments, the lamination process can also involve the use of alternative adhesives, such as ethylene-vinyl acetate (EVA) or acrylic-based adhesives, depending on specific filtration requirements. Acrylic-based adhesives can also be used and provide excellent bonding strength and are ideal for applications where chemical resistance is a priority. The selection of adhesive material and lamination technique is tailored to the environmental demands, ensuring the filter maintains its structural integrity, airflow, and filtration capabilities under various operating conditions.

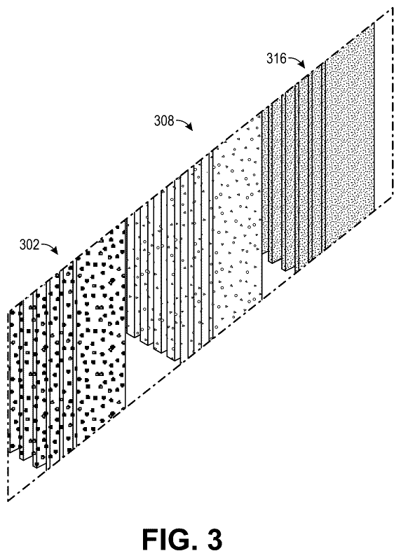

FIG. 3 provides a detailed, magnified view of each layer within the air filter system. By utilizing multiple filter media types—including mechanical, electrostatic, nanofiber, and synthetic media—the air filter achieves efficient humidity control and particulate capture, addressing the needs of diverse and challenging environmental applications.

The first layer 302 is illustrated as a hydrophobic, non-woven fleece layer. The first layer 302 can comprise materials such as polypropylene, polyester, and polyethylene, selected for their moisture-repellent properties and low resistance to airflow. Alternatively, other materials such as polyvinylidene chloride (PVDC) or fluoropolymer-coated fibers such as polytetrafluoroethylene (PTFE)-coated polyester can be used. Blended materials, such as a polypropylene and PTFE combination, can be used. Additionally, a spunbond-meltblown-spunbond composite can be used for the first layer 302. The basis weight for the first layer 302 can be less than 2.7 grams per square foot to maintain optimal permeability, though the first layer 302 can range from 1.5 to 3.5 g/ft² to suit specific environmental and filtration requirements. The thickness of the first layer 302 ranges from 0.3 mm to 1 mm. In additional embodiments, the thickness of the first layer 302 can be within a range of 0.1 mm to 5 mm. In more additional embodiments, polymers such as PVDF or PTFE can be used for enhanced chemical resistance and thermal stability. PTFE, with its higher melting point, provides long-term durability in high-temperature applications, while PVDF is highly resistant to UV exposure, making it suitable for outdoor or high-stress settings.

The second layer 308 may comprise a lofted, non-woven structure, chemically treated for hydrophobicity. This lofted layer is configured to capture additional moisture without impeding airflow. In some embodiments, the second layer 308 has a basis weight between 8 g/ft² and 10 g/ft². In additional embodiments, the second layer 308 can range from 5 to 12 g/ft². Furthermore, in various embodiments, the basis weight of the second layer 308 can fall within a range, including 5 g/ft² to 30 g/ft², 8 g/ft² to 25 g/ft², 10 g/ft² to 20 g/ft², and 15 g/ft² to 30 g/ft². The thickness of the second layer 308 is within a range of 1.0 mm to 15 mm. In additional embodiments, the thickness of the second layer 308 can be within a range of 1.0 mm to 25 mm. In further embodiments, the thickness can fall within a range such as 7 mm to 12 mm, 5 mm to 10 mm, or 5 mm to 12 mm. In further embodiments, the thickness may have ranges such as 3 mm to 20 mm, 6 mm to 18 mm, and 10 mm to 25 mm.

Materials for the second layer 308 may include polyethylene terephthalate (PET) and polypropylene. Synthetic-natural fiber blends, such as polyester mixed with cellulose, can be used. In additional embodiments, materials like carbon-infused fibers and silicon-coated fibers can be used. Blends of acrylic and PET with a fluorinated coating can be utilized for chemical resistance and moisture repellency. In other embodiments, additional materials or combinations of materials can be used, which are hydrophobic, spun bond, and non-woven.

The second layer 308 is chemically treated with a hydrophobic treatment. The chemical hydrophobic treatment, which can be polysiloxane, fluorinated compounds, or silicone-based coatings, is uniformly applied to the fibers to ensure consistent water repellency across the second layer 308. Alternative hydrophobic coatings may include ethylene-vinyl acetate (EVA) or acrylic resins, which provide added flexibility and durability in varied environmental conditions. Additional hydrophobic coatings can be used and are not specifically described herein. The lofted, open configuration of this layer supports moisture capture and deflection, working as a secondary moisture barrier that captures particles and repels residual humidity while maintaining airflow.

The third layer 316 serves as the primary particulate capture layer, comprising a dense, non-woven material optimized for particle retention. The basis weight of the third layer 316 can range from 15 g/ft² to 30 g/ft². In additional embodiments, the basis weight may vary across ranges such as 10 g/ft² to 35 g/ft², 6 g/ft² to 15 g/ft², 8 g/ft² to 20 g/ft², or 12 g/ft² to 25 g/ft².

The thickness of the third layer 316 can be within the range of 0.5 mm to 5 mm. In further embodiments, the thickness can fall within other ranges, such as 3.0 mm, 2 mm to 10 mm, 3 mm to 10 mm, 1 mm to 8 mm, or 4 mm to 9 mm, allowing for adaptability to specific performance requirements. The thickness of the third layer 316 can be withing the range of between 0.5 mm and 5 mm. In additional embodiments, the thickness of the third layer 316 is 3.0 mm. In some embodiments, materials for the third layer 316 include high-density polypropylene and polyester. Additional materials can be used such as polyimide fibers. Glass fibers may also be used. For fine particulate capture, PTFE membranes or nanofiber media composed of ultrafine fibers like polypropylene, PTFE, or polyethylene may be integrated into this layer's structure.

In additional embodiments, the third layer 316 can use PTFE membranes. In applications involving submicron particles, a range of nanofiber media can be integrated into the third layer 316 to enhance filtration performance while maintaining airflow. Examples of nanofiber options include polyimide nanofibers for high-temperature industrial applications, nylon nanofibers for environments requiring strong mechanical resilience, and electro spun PLA fibers for disposable filters with a focus on biodegradability. Carbon nanotube-infused nanofibers or glass fiber composites may also be included in applications with high dust loads and chemical contaminants. Additionally, electrostatically charged synthetic media may be embedded to enhance capture efficiency by attracting and retaining particles as they move through the filtration matrix. Additional materials, or a combination of materials, can be used that are not described herein. This dense, fibrous structure ensures high particulate retention, achieving a MERV rating between 8 and 11 or higher, with a minimum rating of MERV 10. In additional embodiments, the MERV rating can range from 8 to 13, 10 to 12, or 10 or above, providing enhanced filtration performance suitable for a variety of applications.

In some embodiments, the third layer 310 can comprise an electrostatic medium. When electrostatic media is used, materials such as polyamide (nylon) or polyester may be electrostatically charged, providing a mechanism for attracting oppositely charged particles, thereby improving capture efficiency under low-flow conditions. For applications requiring high-efficiency particle capture, a variety of nanofiber compositions can be layered atop the non-woven substrate. Examples include electrospun polypropylene (PP) nanofibers, polyvinylidene fluoride (PVDF), or polytetrafluoroethylene (PTFE) fibers. Other configurations may include polyamide (nylon) nanofibers, acrylic-polyethylene composite nanofibers, or cellulose acetate fibers. These nanofiber layers create a micro-porous surface that captures smaller particulates while preserving air permeability. Additionally, synthetic fiber blends such as acrylic and nylon can be incorporated to enhance tensile strength and flexibility. Additional materials can be used for the third layer 310 that are not described herein.

The third layer 310 may incorporate electrostatic filtering capabilities by treating materials like PET or polypropylene with a static charge, allowing for the capture of both dust and moisture particles through electrostatic attraction. For applications requiring submicron particle filtration, a nanofiber layer composed of ultrafine synthetic fibers (e.g., PET, PTFE, or polypropylene) may be laminated on top of a lofted structure, providing a fine, porous surface that enhances particle capture while minimizing airflow restriction.

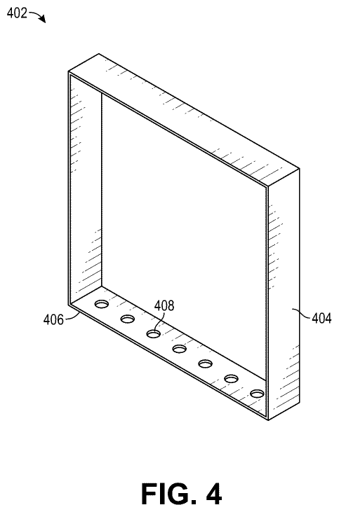

FIG. 4 illustrates frame 402, which serves as the foundational support for the multi-layer air filter assembly. This frame secures each filtration layer in place, allowing for efficient water drainage and maximizing air exposure across the filter's surface. Constructed from non-metal, non-woven materials, the frame is durable, lightweight, and highly resistant to corrosion and wear, making it suitable for extended use in demanding industrial, commercial, and environmental applications. The choice of non-metal construction also ensures compatibility with wet or humid environments, where traditional metal frames could corrode and degrade over time.

Frame material 404 is depicted with a smooth, seamless structure, free from sharp edges or protrusions that could obstruct airflow or impede water drainage. In some embodiments, the frame material 404 is made from polyester due to its strength and resistance to environmental stress. The frame material 404 can also comprise other non-metallic compositions based on application needs. These options include, but are not limited to, polyethylene, polypropylene, and nylon. For environments where flame resistance or additional stability is needed, polyimide or aramid fibers (such as Kevlar) may be incorporated, offering high resistance to temperature and chemical exposure. Additionally, thermoplastic elastomers (TPE) can be used to add flexibility and shock absorption, while polyvinyl chloride (PVC) and ethylene-vinyl acetate (EVA) are suitable for applications requiring extra rigidity and moisture resistance.

Alternative materials for frame 402 and frame material 404 include synthetic rubber compounds like nitrile butadiene rubber (NBR) for applications requiring superior sealing capabilities, high-density polyethylene (HDPE), or acrylonitrile butadiene styrene (ABS) for environments requiring increased structural rigidity. For eco-friendly or biodegradable options, polylactic acid (PLA) or recycled fibers may be incorporated, catering to installations emphasizing sustainability.

In one embodiment, frame 402 comprises a lipless edge 406. This lipless edge 406 prevents moisture accumulation at the edges, allowing water repelled by the filtration layers to flow freely from the assembly. This design also promotes uniform airflow across the filter, preventing localized air pressure drops that could reduce filtration efficiency near the frame boundaries. By removing traditional frame lips or overhangs, the frame enhances the performance of each filtration layer, maintaining consistent pressure across the filter and ensuring optimal airflow distribution.

In additional embodiments, drainage paths 408 are integrated into the frame to facilitate water evacuation, preventing the accumulation of moisture within the filter assembly. These drainage paths 408 are smooth and angled, allowing water collected by the filter layers to flow downward and out of the frame via gravity. This design minimizes the risk of moisture interfering with the filter's airflow and prevents any water pooling that could lead to clogging or reduced filtration efficiency over time. The drainage paths 408 can be merely holes in the bottom of frame 402, or they can be lined with materials that encourage water flow. The materials used to line the drainage paths 408 can be hydrophobic to encourage water flow; materials like silicone-treated polyester or EVA are used due to their hydrophobic and flexible properties. The drainage paths 408 ensure that the filtration process remains continuous and uninterrupted, supporting the filter's longevity and operational consistency.

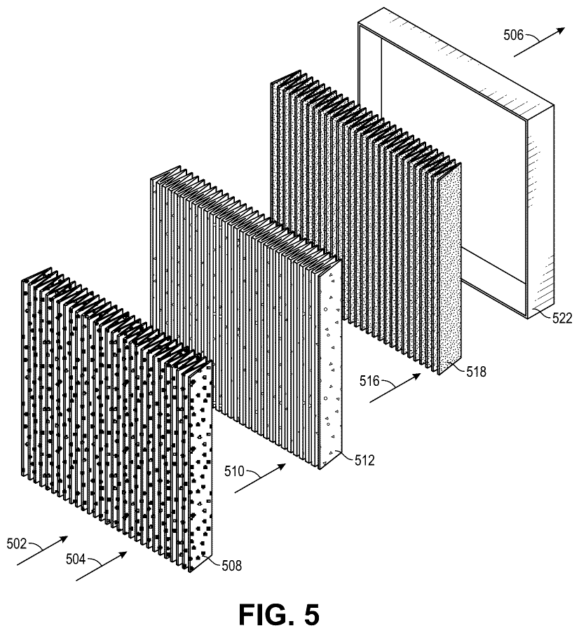

FIG. 5 provides a diagram of the airflow or air stream path and filtration process across the multi-layer air filter, illustrating how the system sequentially removes moisture and particulates while progressively decreasing airflow velocity. The airflow path 502 is delineated by directional arrows, marking the movement of air as it enters from the upstream side 504, traverses each filtration layer, and exits at the downstream side 506. This structured diagram highlights each layer's role in achieving staged moisture reduction and particle capture.

Air enters the upstream side 504, carrying elevated levels of humidity and particulate matter. Upon reaching the first layer 508, initial humidity reduction occurs as the air encounters a hydrophobic non-woven fleece material. This layer's construction leverages tightly bound fibers of hydrophobic materials, such as polypropylene or polyester, which repel moisture upon contact. The fleece's microstructure and hydrophobic properties work to reduce the air's relative humidity through inertial separation, forcing moisture particles to collide with and adhere to the fiber surfaces. This initial interaction also decreases the air velocity slightly, as the fleece's fiber density disperses the incoming airstream, setting the stage for further moisture capture as the air progresses downstream.

The partially dehumidified air 510 then enters the second layer 512, a lofted, chemically treated material designed to achieve additional moisture reduction. This layer features a hydrophobic coating, such as polysiloxane or fluorinated compounds, applied uniformly across its fibers, as depicted by the coating layer in the diagram. The lofted structure of this second layer creates an expanded surface area and increased fiber spacing, which enhances water capture and redirects remaining moisture particles. As air moves through this layer, its velocity is further reduced due to the layer's volumetric design, which slows the airstream without substantial resistance. This deceleration enables more effective moisture capture, as moisture-laden air is retained in the layer longer, allowing hydrophobic surfaces to repel water particles downward, away from the airstream.

Following moisture reduction in the second layer, the low-humidity air 516 advances into the third layer 518, where particulate capture is the primary function. This dense, non-woven layer is comprised of fibers arranged to maximize particle adhesion, effectively capturing particles of various sizes. The layer's fibrous structure and density increase the contact points for particle adherence, ensuring that particulate matter is retained within the filtration matrix as the airstream passes through. As air exits this final layer, it exhibits low particulate content, having undergone thorough filtration across progressively specialized media layers.

Surrounding the filter assembly, frame 522 provides structural stability. In some embodiments, the frame 522 does not have drainage holes like those depicted in FIG. 4. This cohesive design allows the filter's structural and functional elements to operate in tandem, optimizing moisture and particulate reduction while maintaining efficient air velocity control throughout the system.

Collectively, the multi-layered structure of FIG. 5 uses a combination of hydrophobic, lofted, and particulate-capturing layers that function synergistically to reduce humidity and capture airborne particles effectively. The filter provides a filtration efficiency with a minimum MERV rating of 8, though configurations may reach MERV 13 or higher depending on specific material compositions and layer thicknesses. The initial pressure drop of the filter is generally below 0.4 inches of water gauge (WG) at an airflow rate of 500 feet per minute (fpm); however, it may vary slightly based on environmental conditions, with a range of 0.2 to 0.5 inches WG at airflow rates between 400 and 600 fpm. Additionally, the filter boasts a dust-holding capacity of no less than 500 grams at a final pressure drop of 2 inches WG. In additional embodiments, the dust-holding capacity can vary from 400 to 800 grams, with a corresponding final pressure drop ranging from 1.8 to 2.5 inches WG.

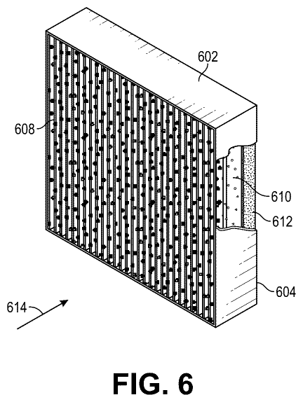

FIG. 6 provides a perspective view of the fully assembled multi-layer air filter, showing the cohesive arrangement of the layers and the frame in a practical configuration. This view represents the filter as it would appear in use, with each layer securely positioned within the frame 602 and arranged to ensure optimal air filtration.

The frame 602, is illustrated with lipless edges 604, allowing for unobstructed airflow across the filter surface and easy drainage of moisture. This view highlights the smooth, open edges of the frame, emphasizing how it maximizes surface exposure for efficient filtration. Constructed from non-metal, non-woven material, the frame is both durable and lightweight, suitable for integration into various air filtration systems.

The filter layers are shown in sequence through a cutout in the frame 602, beginning with the first layer 608 on the upstream side, progressing through the second lofted layer 610, and ending with the third layer 612 on the downstream side. The perspective arrangement provides an understanding of the filter's depth and thickness, demonstrating how each layer is spaced within the frame to perform its designated function—moisture reduction in the first and second layers, followed by particulate capture in the third layer. Airflow 614, shows how air enters through the upstream side, moves sequentially through each layer, and exits from the downstream side. This perspective view allows for a practical visualization of how air progresses through the filter, passing through each layer in a structured manner that optimizes humidity and particulate reduction.

In some embodiments, frame 602 can include mounting elements that hold each layer in place, although these elements are not immediately visible in the perspective view. However, their presence ensures that each layer remains securely positioned during filtration, allowing for consistent performance and reducing the likelihood of displacement during operation. This stability is essential for applications that require continuous airflow without interruption.

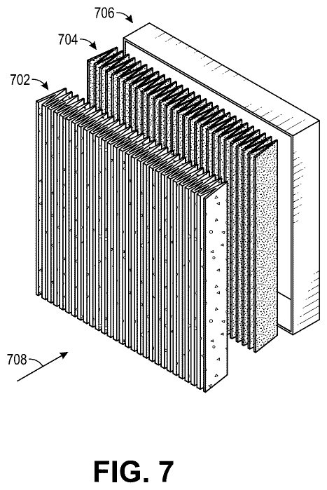

FIG. 7 depicts an expanded or exploded view of a two-layer air filtration assembly specifically engineered for combined moisture reduction and particulate removal in an incoming airstream. The assembly includes a first layer 702, a second layer 704, a frame 706, and an airflow direction 708 indicated by arrows. Unlike traditional filters designed solely for particulate capture, the filter assembly of FIG. 7 is configured to simultaneously address suspended liquid moisture and airborne solids while maintaining low resistance to airflow. The structural relationship between the hydrophobic first layer 702, the lofted second layer 704, and the drainage-optimized frame 706 enables the system to achieve levels of humidity reduction and droplet removal that exceed what would be expected from passive non-desiccant filters.

In some embodiments, the first layer 702 is positioned on the upstream or air-entry side and functions as the primary hydrophobic interface that initiates moisture separation. The first layer 702 may be formed as a single hydrophobic sheet or as a laminate of two or more hydrophobic layers, depending on the operational humidity range. Each hydrophobic layer may be composed of non-woven, low-density fibers configured to repel water rather than absorb it. Upon contact with humid air, the hydrophobic fibers induce inertial impaction and coalescence of micro-droplets, causing the droplets to migrate across the fiber surfaces and merge into larger droplets that can be shed rather than retained. This moisture-shedding behavior occurs because the hydrophobic fibers exhibit water contact angles greater than 90°, and in some embodiments greater than 150°, reducing the adhesive force between droplets and the fiber surfaces. The ability of the first layer 702 to immediately reduce moisture intrusion into downstream layers is a departure from the behavior of conventional HVAC filters, which typically retain moisture and experience increased pressure drop when exposed to humidity.

Suitable materials for the first layer 702 include but are not limited to, lightweight, non-woven hydrophobic materials such as polypropylene, polyester, polyethylene, polyvinylidene fluoride (PVDF), or polytetrafluoroethylene (PTFE). These materials allow air to flow freely while effectively blocking moisture. In some embodiments, the hydrophobic nature of the first layer 702 may be chemically enhanced through the application of silicon-based coatings, fluorinated polymeric treatments, or other water-repellent surface modifications that further increase contact angle and lower surface energy. The combination of hydrophobic chemistry and micro-scale fiber structure enables the first layer to remove moisture in the form of droplets as small as approximately 0.8 microns—an unexpected performance characteristic for a filtration system that does not employ absorbent or desiccant materials.

The second layer 704 is positioned downstream of the first layer 702 and is configured as a lofted, self-supporting structure for particulate filtration. The second layer 704 may be comprised of similar materials as each of the particle removal layers described above, such as third layer 114 third layer 210, third layer 316, third layer 518, or third layer 612. The frame 706 encases the assembly and provides structural support for the layers. The frame 706 can be constructed from non-metal, non-woven materials such as polyester, polyethylene, or thermoplastic elastomers. The airflow direction 708, depicted by arrows, enters through the first layer 702, flows through the second layer 704, and exits the filter assembly.

The selection of one or two hydrophobic layers in the first layer 702 depends on the relative humidity (RH) of the incoming air. For high humidity conditions, a single hydrophobic layer is more effective, as it achieves a greater reduction in relative humidity compared to multiple layers. For example, when the incoming air had an RH of 90%, a single hydrophobic layer reduced the RH by 22.5%, whereas two hydrophobic layers reduced it by only 16.6%. Conversely, under moderate humidity conditions, such as an incoming RH of 70%, the change in relative humidity was relatively similar for both configurations, with a reduction of approximately 7% for one and two layers. These findings guide the optimal configuration of the first layer 702 based on environmental conditions to ensure efficient humidity management without compromising airflow.

Performance data for the disclosed two-layer hydrophobic air filtration system demonstrate a series of results that are technically significant and unexpected in view of known HVAC filtration behavior. Unlike conventional pleated particulate filters, which lack any mechanism for coalescing or shedding moisture, the disclosed system meaningfully reduces the relative humidity of an incoming airstream. Testing showed reductions of up to approximately 21% simply by passing humid air through the two-layer arrangement, without the use of desiccants, cooling coils, or active dehumidification equipment.

Humidity-analysis data confirm this unexpected behavior. At an inlet condition of 80° F. and 90% relative humidity (RH), the downstream RH measured 70%, reflecting a reduction of more than 22%. At 80° F. and 95% RH, the downstream RH measured 74%, again showing a reduction of approximately 22%. Even under moderate humidity conditions, such as 80° F. and 70% RH, the downstream RH measured 57%, representing a reduction of nearly 19%. These reductions indicate that the system removes a measurable mass of water vapor or entrained liquid droplets from the airstream while maintaining high airflow permeability. A person of ordinary skill in the art would not expect any passive HVAC filter—especially one without an absorbent or moisture-retaining medium—to achieve humidity reductions of this magnitude.

The data further demonstrate that the system can remove suspended moisture droplets far smaller than those typically captured by passive fibrous media. Droplets as small as approximately 0.8-1.0 microns were removed at efficiencies exceeding 60%, and the capture efficiency increased systematically with droplet size, reaching above 96% at approximately 4-5 microns. Conventional HVAC filters permit microdroplets in this size range to pass unimpeded, as such droplets generally follow airflow streamlines and lack sufficient inertia to impact or adhere to filter fibers. By contrast, the disclosed two-layer structure produces sub-micron droplet removal in a manner that is counterintuitive given its simple construction.

These results reveal an unexpected interaction between the hydrophobic first layer and the lofted second layer. The hydrophobic upstream layer repels water and promotes initial droplet coalescence, while the downstream lofted layer provides additional residence time and controlled turbulence that encourages droplet growth and shedding without absorption. This passive moisture-management mechanism differs fundamentally from prior-art filters, which either trap water—leading to increased pressure drop and rapid saturation—or do not interact with moisture at all.

The humidity-reduction behavior occurs immediately upon installation. The system produced measurable humidity reduction as soon as humid air contacted the hydrophobic layer, without any warm-up period, media conditioning, or saturation time. This immediate response further distinguishes the disclosed system from absorbent or desiccant filters, which require equilibration, and from cooling-based humidity control systems, which require temperature differentials not present in typical HVAC ducting.

Pressure-drop performance further confirms the unexpected nature of the system's operation. At an airflow rate of approximately 1968 cubic feet per minute, the initial pressure drop measured approximately 0.309 inches of water gauge—consistent with ordinary MERV-11 particulate filters and inconsistent with any system that retains significant quantities of water. Conventional filters that absorb or trap moisture show increasing pressure drop as humidity rises, but the disclosed system maintained a low, stable resistance throughout humid operation. This demonstrates that the system does not behave like a desiccant or sponge but instead promotes directional moisture shedding facilitated by the interaction of the hydrophobic and lofted layers and the drainage-optimized lipless frame.

Additional unexpected behavior was observed in the relationship between humidity reduction and the number of hydrophobic layers used. At high inlet humidity levels, a configuration with a single hydrophobic layer produced greater humidity reduction than a configuration with two hydrophobic layers. For example, at 90% inlet RH, the single-layer configuration achieved a reduction of approximately 22.5%, while the two-layer configuration achieved approximately 16.6%. At lower humidity levels (e.g., 70% RH), both configurations performed similarly, producing reductions of approximately 7%. This non-linear performance contradicts the intuitive assumption that adding hydrophobic material would increase moisture-repelling capability. Instead, the data show that the aerodynamic interaction between layer spacing, fiber structure, and airflow velocity drives the humidity-reduction mechanism. These dynamics are not predictable from hydrophobicity alone and are not taught or suggested by known filters.

Taken together, the unexpectedly large humidity reductions, the high removal efficiency of sub-micron droplets, the immediate onset of humidity-reduction behavior, the stable low pressure drop during humid operation, and the counterintuitive superiority of the single-layer hydrophobic configuration all demonstrate that the disclosed two-layer filtration system exhibits properties fundamentally different from the behavior of conventional HVAC filters. These results show that the specific arrangement of a hydrophobic upstream layer, a lofted downstream layer, and a drainage-optimized frame creates a synergistic, non-obvious mode of operation responsible for the system's enhanced performance and supports the patentability of the two-layer design.

Although the two-layer configuration provides unexpectedly high humidity-reduction and droplet-removal efficiency, the system architecture is modular, and additional layers may be incorporated in alternative embodiments. Such layers may be selected to increase particulate-capture capacity, extend service life, or tailor airflow characteristics for specific installations. The underlying coalescence and drainage principles observed in the two-layer system indicate that optional downstream layers may be integrated without diminishing the core moisture-management performance.

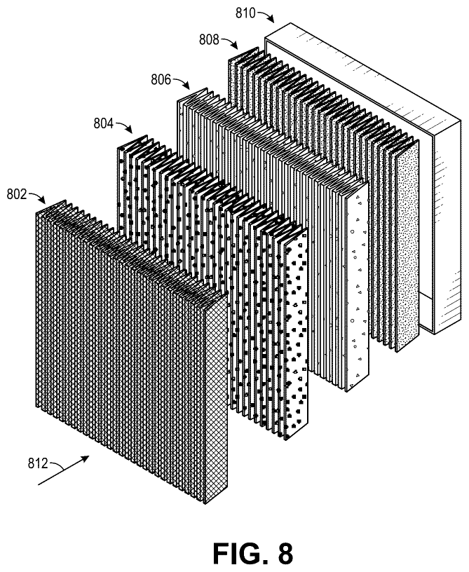

FIG. 8 illustrates an expanded or exploded view of a four-layer air filtration assembly designed for enhanced moisture and particulate management in an incoming airstream. The assembly includes a first layer 802, a second layer 804, a third layer 806, a fourth layer 808, a frame 810, and an airflow direction 812, as indicated by arrows.

The first layer 802 is positioned on the upstream or air entry side and serves as an initial hydrophobic barrier. This layer can be a single layer or a plurality of layers. The second layer 804 is also a hydrophobic layer, positioned downstream of the first layer 802. The third layer 806, located downstream of the second layer 804, is another hydrophobic layer. By incorporating multiple hydrophobic layers, the assembly is capable of handling higher volumes of moisture while maintaining effective airflow. One or more of the first layer 802, the second layer 804, and the third layer 806 have a water contact angle of 90 degrees or larger. In some embodiments, one or more of the first layer 802, the second layer 804, and the third layer 806 have a water contact angle of greater than 150 degrees.

The fourth layer 808, positioned downstream of the third layer 806, is similar to the second layer 704 described with respect to FIG. 7. It is a lofted, self-supporting structure designed primarily for particulate filtration. The frame 810 encases the four-layer assembly and provides structural support and is similar to the frame 118 described with respect to FIG. 1. The airflow direction 812, depicted by arrows, enters through the first layer 802 and sequentially passes through the second layer 804, third layer 806, and fourth layer 808 before exiting the assembly.

Clause 1. An air filtration system for reducing both humidity and particulate matter in an air stream, comprising: a first layer comprising one or more hydrophobic layers; a second layer positioned downstream of the second layer, comprising a dense non-woven material optimized for particulate capture; and a non-metal, non-woven frame encasing each of the first layer, the second layer, and the third layer, configured to facilitate water drainage and maximize air exposure across the air filtration system.

Clause 2. The air filtration system of clause 1, wherein the first layer is comprised of polypropylene or polyester.

Clause 3. The air filtration system of clause 1, wherein the second layer includes hydrophobic compounds selected from polysiloxane, fluorinated polymers, or silicone-based coatings.

Clause 4. The air filtration system of clause 1, wherein the third layer comprises glass fibers.

Clause 5. The air filtration system of clause 1, wherein the non-metal, non-woven frame includes drainage paths.

Clause 6. The air filtration system of clause 1, wherein a frame material is selected from polyethylene, polypropylene, or thermoplastic elastomers.

Clause 7. The air filtration system of clause 1, wherein the second layer further includes electrostatically charged synthetic fibers for enhanced particulate capture.

Clause 8. The air filtration system of clause 1, wherein the first layer is laminated to the second layer, and the second layer is laminated to the third layer using a thermosetting resin.

Clause 9. The air filtration system of clause 1, wherein the non-metal, non-woven frame includes a lipless edge.

Clause 10. A multi-layer air filter for sequential moisture and particulate reduction in an air stream, comprising: an upstream layer of non-woven hydrophobic material configured to deflect moisture upon contact; an intermediate lofted layer comprising non-woven synthetic fibers treated with water-repellent compounds to capture residual moisture; a downstream dense fibrous layer designed to retain particulate matter and reduce air contaminants; and a supporting frame made from non-metal materials, wherein the supporting frame comprises one or more drainage paths.

Clause 11. The multi-layer air filter of clause 10, wherein the upstream layer is comprised of a material selected from polyethylene or polyvinylidene fluoride.

Clause 12. The multi-layer air filter of clause 10, wherein the intermediate lofted layer is treated with a silicone-based hydrophobic coating.

Clause 13. The multi-layer air filter of clause 10, wherein the downstream dense fibrous layer is embedded with PTFE membranes for capturing fine particles.

Clause 14. The multi-layer air filter of clause 10, wherein the supporting frame is comprised of polyester with integrated hydrophobic properties to facilitate moisture drainage.

Clause 15. The multi-layer air filter of clause 10, wherein the intermediate lofted layer incorporates melt-blown fibers for self-supporting structural stability.

Clause 16. The multi-layer air filter of clause 10, wherein the supporting frame is formed from recycled materials.

Clause 17. The multi-layer air filter of clause 10, wherein the intermediate lofted layer has a basis weight ranging from 5 to 12 grams per square foot.

Clause 18. The multi-layer air filter of clause 10, wherein the supporting frame includes a lipless edge.

Clause 19. A filtration assembly for reducing humidity and particulate content in an air stream, comprising: a first hydrophobic layer on an upstream side configured to prevent moisture intrusion; a second lofted hydrophobic layer positioned downstream, comprising a chemically treated structure to capture residual moisture with minimal airflow resistance; a third dense particulate-capturing layer positioned downstream, configured to retain particulate matter from the air stream; and a non-metallic frame configured to support each layer and direct filtered water away from the filtration assembly.

Clause 20. The filtration assembly of clause 19, wherein the first hydrophobic layer is made from polyester or polyvinylidene fluoride for enhanced chemical resistance.

Clause 21. The filtration assembly of clause 19, wherein the second lofted hydrophobic layer is coated with polysiloxane for uniform water repellency.

Clause 22. The filtration assembly of clause 19, wherein the third dense particulate-capturing layer includes nanofiber media embedded for enhanced fine particle capture.

Clause 23. The filtration assembly of clause 19, wherein the non-metallic frame comprises non-metal thermoplastic elastomers for enhanced flexibility and resistance to environmental stress.

Clause 24. The filtration assembly of clause 19, wherein the second lofted hydrophobic layer has a thickness of between 5 mm and 15 mm.

Clause 25. The filtration assembly of clause 19, wherein the non-metallic frame incorporates an angled drainage channel.

Clause 26. The filtration assembly of clause 19, wherein the first hydrophobic layer comprises an electrostatically charged polyamide layer.

Clause 27. The filtration assembly of clause 19, wherein the filtration assembly has a minimum MERV rating of 8.

Although the present disclosure has been described with reference to the embodiments illustrated in the attached drawing figures, it is noted that equivalents may be employed and substitutions made herein without departing from the scope of the present disclosure as recited in the claims.

Having thus described various embodiments of the present disclosure, what is claimed as new and desired to be protected by Letters Patent includes the following:

1. An air filtration system for reducing both humidity and particulate matter in an air stream, comprising:
a first layer comprising one or more hydrophobic layers, the one or more hydrophobic layers having a water contact angle of at least 90 degrees;
a second layer positioned downstream of the first layer, comprising a non-woven material for particulate capture; and
a non-metal, non-woven frame encasing each of the first layer and the second layer, the non-woven frame including a lipless edge configured to facilitate water drainage.

2. The air filtration system of claim 1, wherein the first layer is comprised of polypropylene or polyester.

3. The air filtration system of claim 1, wherein the first layer includes hydrophobic compounds selected from polysiloxane, fluorinated polymers, or silicone-based coatings.

4. The air filtration system of claim 1, wherein the second layer comprises glass fibers.

5. The air filtration system of claim 1, wherein the non-metal, non-woven frame includes drainage paths.

6. The air filtration system of claim 1, wherein a frame material is selected from polyethylene, polypropylene, or thermoplastic elastomers.

7. The air filtration system of claim 1, wherein the second layer further includes electrostatically charged synthetic fibers.

8. The air filtration system of claim 1, wherein the first layer is laminated to the second layer using a thermosetting resin.

9. The air filtration system of claim 1, wherein the non-metal, non-woven frame includes a lipless edge.

10. A multi-layer air filter for sequential moisture and particulate reduction in an air stream, comprising:
an upstream layer of non-woven hydrophobic material configured to deflect moisture upon contact;
an intermediate lofted layer comprising non-woven synthetic fibers treated with hydrophobic compounds;
a downstream dense fibrous layer configured to retain particulate matter and reduce air contaminants; and
a supporting frame made from non-metal materials, wherein the supporting frame comprises one or more drainage paths.

11. The multi-layer air filter of claim 10, wherein the upstream layer is comprised of a material selected from polyethylene or polyvinylidene fluoride.

12. The multi-layer air filter of claim 10, wherein the intermediate lofted layer is treated with a silicone-based hydrophobic coating.

13. The multi-layer air filter of claim 10, wherein the downstream dense fibrous layer is embedded with PTFE membranes.

14. The multi-layer air filter of claim 10, wherein the supporting frame is comprised of polyester with integrated hydrophobic properties.

15. The multi-layer air filter of claim 10, wherein the intermediate lofted layer incorporates melt-blown fibers.

16. The multi-layer air filter of claim 10, wherein the supporting frame is formed from recycled materials.

17. The multi-layer air filter of claim 10, wherein the intermediate lofted layer has a basis weight ranging from 5 to 12 grams per square foot.

18. The multi-layer air filter of claim 10, wherein the supporting frame includes a lipless edge.

19. A filtration assembly for reducing humidity and particulate content in an air stream, comprising:
a first hydrophobic layer on an upstream side;
a second lofted hydrophobic layer positioned downstream of the first hydrophobic layer, comprising a chemically treated structure;
a third dense particulate-capturing layer positioned downstream of the second lofted hydrophobic layer, configured to retain particulate matter from the air stream; and
a non-metallic frame configured to support each layer and direct filtered water away from the filtration assembly.

20. The filtration assembly of claim 19, wherein the first hydrophobic layer is made from polyester or polyvinylidene fluoride.
